(19) United States
(12) Patent Application Publication
(10) Pub. No.: US 2014/0263815 A1
(43) Pub. Date: Sep. 18, 2014

(54) Cable Assemblies and Associated Systems and Methods

(71) Applicants: Gregg J. LaFontaine, Lebanon, CT (US); Adam Murano, San Marcos, CA (US)

(72) Inventors: Gregg J. LaFontaine, Lebanon, CT (US); Adam Murano, San Marcos, CA (US)

(73) Assignee: ORTRONICS, INC., New London, CT (US)

(21) Appl. No.: 14/210,665

(22) Filed: Mar. 14, 2014

Related U.S. Application Data
(60) Provisional application No. 61/793,130, filed on Mar. 15, 2013.

(51) Int. Cl. B65H 49/32; F16G 11/00

(52) U.S. Cl. CPC B65H 49/322; F16G 11/00
USPC 242/594.5; 24/115 R; 29/428

(57) ABSTRACT

Exemplary embodiments are directed to cable assemblies that generally include a first cable and a second cable. The first cable includes a first elongated cord defining two ends, a first connector mounted with respect to one end of the first elongated cord, and a first bare cable defining an opposing end of the first elongated cord. The second cable includes a second elongated cord defining two ends, a second connector mounted with respect to one end of the second elongated cord, and a second bare cable defining an opposing end of the second elongated cord. The cable assemblies generally include a coupler element for detachably securing the first cable relative to the second cable with the first bare cable and the second connector in a juxtaposed relation. Exemplary embodiments are also directed to systems and methods of cable assembly packaging and payout.

### CROSS-REFERENCE TO RELATED APPLICATIONS

The present application claims priority to a U.S. provisional patent application entitled “Cable Assemblies and Associated Systems and Methods,” filed with the U.S. Patent and Trademark Office on Mar. 15, 2013, and assigned Ser. No. 61/793,130. The entire content of the foregoing provisional patent application is incorporated herein by reference.

### TECHNICAL FIELD

The present disclosure relates to cable assemblies and associated systems and methods and, in particular, to cable assemblies for efficient packaging and payout of cables with at least one bare end.

### BACKGROUND

Cables, e.g., patch cords, Category 5, Category 6, Category 6A, fiber optic cables, cables with plug and/or jack connectors, cables with bare ends, and the like, are generally used in a variety of settings to create electrical connections for communication between electronic devices, e.g., networking between switches, servers, data storage devices, and the like. In packaging and/or supplying cables to the trade, manufacturers generally package cables individually, e.g., in plastic packaging. In addition, the site preparation prior to installation of cables generally requires an inventory of necessary cables to be allocated, the cables to be sorted, removed from their unit packaging, unbundled, and finally uncoiled in order to make the connection. Thus, large amounts of material are typically wasted in packaging cables and each cables must be individually removed prior to installation, thereby slowing the installation process and generally inconveniencing the installer. In an industry where large numbers of cables may be required for installation at one time, individually removing cables from individual packages can lead to lengthy installation times.

Thus, a need exists for cable assemblies, methods and systems that facilitate cost effective packaging and/or efficient cable access and installation in the field. These and other needs are addressed by the cable assemblies and associated systems and methods of the present disclosure.

### SUMMARY

In accordance with embodiments of the present disclosure, exemplary cable assemblies are provided that generally include a first cable and a second cable. The first cable generally includes a first elongated cord defining two ends, a first connector mounted with respect to one end of the first elongated cord, and a first bare cable defining an opposing end of the first elongated cord. The second cable generally includes a second elongated cord defining two ends, a second connector mounted with respect to one end of the second elongated cord, and a second bare cable defining an opposing end of the second elongated cord. The exemplary cable assemblies generally include a coupler element for detachably securing the first cable relative to the second cable with the first bare cable and the second connector in a juxtaposed relation, e.g., an adjoining relation, an opposed relation, a side-by-side relation, a co-planar relation, a spaced relation, a passing relation, combinations thereof, and the like. In some embodiments, the coupler element completely surrounds, covers or encases the first bare end and the second connector.

The first connector and the second connector can be, e.g., a plug, a jack, and the like. The coupler element can be, e.g., a clip, a cover, an elongated band, a rubber band, adhesive tape, combinations thereof, and the like. The coupler element detachably secures the first elongated cord to the second elongated cord. In some embodiments, the cable assemblies can include at least one spacer element removably positioned between the first bare cable and the second connector. The spacer element functions to at least one of prevent or reduce damage to the first bare cable and the second connector, and limit movement of the first bare cable and the second connector relative to each other.

In accordance with embodiments of the present disclosure, exemplary methods of cable assembly are provided that generally include detachably securing a first cable relative to a second cable using a coupler element. The first cable generally includes a first elongated cord defining two ends, a first connector mounted with respect to one end of the first elongated cord, and a first bare cable defining an opposing end of the first elongated cord. The second cable generally includes a second elongated cord defining two ends, a second connector mounted with respect to one end of the second elongated cord, and a second bare cable defining an opposing end of the second elongated cable. The first bare cable and the second connector can be detachably secured in a juxtaposed relation. In some embodiments, the method includes removably positioning at least one spacer element between the first bare cable and the second connector. The spacer element functions to at least one of prevent or reduce damage to the first bare cable and the second connector, and limit movement of the first bare cable and the second connector relative to each other.

In accordance with embodiments of the present disclosure, exemplary systems of cable assembly packaging and payout are provided that generally include a housing for packaging and payout of at least one cable assembly. The at least one cable assembly generally includes at least a first cable and a second cable. The first cable generally includes a first elongated cord defining two ends, a first connector mounted with respect to one end of the first elongated cord, and a first bare cable defining an opposing end of the first elongated cord. The second cable generally includes a second elongated cord defining two ends, a second connector mounted with respect to one end of the second elongated cord, and a second bare cable defining an opposing end of the second elongated cord. In some embodiments, the at least one cable assembly can include a coupler element for detachably securing the at least first cable relative to the at least second cable with the first bare cable and the second connector in a juxtaposed relation. The exemplary systems generally include at least one housing opening for paying out the at least first cable.

The at least one housing opening can be configured and dimensioned to prevent the at least first cable from receding back into the housing. In some embodiments, the at least one housing opening includes a slot configured and dimensioned to prevent the at least first cable from receding back into the housing. In some embodiments, the housing includes a coupler element remover which can be configured and dimensioned to separate the at least first cable and the at least second cable from each other and/or the coupler element. The housing generally includes a handle configured and dimensioned to permit lifting and/or transporting of the housing.

The at least first and second cables can be continuously reeled within the housing around a rotating core. The rotating core generally includes at least one partition which separates and permits independent rotation of at least a first cable assembly relative to a second cable assembly. In some embodiments, the at least first and second cables can be continuously coiled within the housing for dispensing from, e.g., an outer coil diameter to an inner coil diameter, an inner coil diameter to an outer coil diameter, and the like.

Other objects and features will become apparent from the following detailed description considered in conjunction with the accompanying drawings. It is to be understood, however, that the drawings are designed as an illustration only and not as a definition of the limits of the invention.

### BRIEF DESCRIPTION OF THE DRAWINGS

To assist those of skill in the art in making and using the disclosed cable assemblies and associated systems and methods, reference is made to the accompanying figures, wherein:

FIG. 1 is a side view of an exemplary cable assembly with a first and second cable in an opposed relation according to the present disclosure;

FIG. 2 is a side view of an exemplary cable assembly with a first and second cable in a side-by-side relation according to the present disclosure;

FIG. 3 is a side view of an exemplary cable assembly with a first and second cable in a passing, side-by-side relation according to the present disclosure;

FIG. 4 is a side view of an exemplary cable assembly with a first and second cable in a passing, side-by-side relation according to the present disclosure;

FIG. 5 is a partial cutaway view of an exemplary embodiment of a system of cable assembly packaging and payout, including a coiled cable assembly for dispensing from an outer diameter;

FIG. 6 is a partial cutaway view of an alternative exemplary embodiment of a system of cable assembly packaging and payout, including a coiled cable assembly for dispensing from an inner diameter; and

FIG. 7 is a partial cutaway view of an alternative exemplary embodiment of a system of cable assembly packaging and payout, including a spool with partitions.

### DESCRIPTION OF EXEMPLARY EMBODIMENT(S)

With reference to FIG. 1, an exemplary embodiment of a cable assembly 100 is shown. The cable assembly 100 includes a first cable 102 and a second cable 104. The first cable 102 includes a first elongated cord 106 which defines two opposing ends, e.g., a first end 108 and a second end 110. A first connector 112, e.g., a plug, a jack, and the like, can be mounted to the first end 108 of the first elongated cord 106. The second end 110 of the first elongated cord 106 can be defined by a first bare cable 114, e.g., a cable having exposed internal wires for connection to an electrical component. Similarly, the second cable 104 includes a second elongated cord 116 which defines two opposing ends, e.g., a first end 118 and a second end 120. A second connector 122, e.g., a plug, a jack, and the like, can be mounted to the first end 118 of the second elongated cord 116. The second end 120 of the second elongated cord 116 can be defined by a second bare cable 124.

The cable assembly 100 further includes a coupler element 126, e.g., a clip coupler, a cover, one or more elongated bands, and the like, for detachably securing the first cable 102 relative to the second cable 104. For example, a clip coupler can include a grasping means which detachably secures to the first and/or second elongated cords 106, 116 and/or the first and/or second connectors 112, 122. The first and second cables 102, 104 can be separated from each other by unclipping the clip coupler from the desired cable. As a further example, a cover coupler can be a transparent plastic cover which receives therein and is sealed around at least a portion of the first and/or second elongated cords 106, 116 and/or the first and/or second connectors 112, 122. The first and second cables 102, 104 can be separated from each other by breaking the seal of the cover coupler. As yet a further example, one or more elongated band couplers can include band elements which wrap around at least a portion of the first and/or second elongated cords 106, 116 and/or the first and/or second connectors 112, 122 and include score lines at which the elongated band couplers can be torn. The first and second cables 102, 104 can be separated from each other by tearing the appropriate elongated band coupler at the score line to release the desired cable.

In particular, the coupler element 126 detachably secures the first cable 102 relative to the second cable 104 such that the first bare cable 114 and the second connector 122 are positioned in a juxtaposed relation, e.g., an adjoining relation, an opposed relation, a side-by-side relation, a co-planar relation, a spaced relation, a passing relation, combinations thereof, and the like. The clip coupler element 126 can be detachably secured around the first bare cable 114 and the second connector 122 by, e.g., inserting the first bare cable 114 and the second connector 122 between two spring-loaded surfaces which compress around the first bare cable 114 and the second connector 122. It should be noted that the compression created by the spring-loaded surfaces can be gauged to securely hold the first bare cable 114 and the second connector 122, while preventing damage to the first bare cable 114 and the second connector 122.

FIG. 1 shows the first and second cables 102, 104 detachably coupled by the coupler element 126 such that the first bare cable 114 and the second connector 122 are in an opposed, spaced and co-planar relation. In particular, the first and second cables 102, 104 are positioned such that the first bare cable 114 faces the second connector 122 and the first and second elongated cords 106, 116 are substantially aligned relative to each other. The coupler element 126 can, for example, surround, cover and/or encase the first bare cable 114 and the second connector 122. In some embodiments, the coupler element 126 can surround, cover and/or encase portions of the first and second elongated cords 106, 116 adjacent to the first bare cable 114 and/or the second connector 122. The first cable 102 and the second cable 104 can be detached from the coupler element 126 (and from each other) by, e.g., pulling the first bare cable 114 or the second connector 122 from the coupler element 126, breaking or tearing the coupler element 126, releasing or opening the spring-loaded surfaces of the coupler element 126, and the like. In some embodiments, the coupler element 126 can be fabricated from a flexible material, e.g., a plastic, such that the cable assembly 100 can be coiled and/or reeled within a housing for packaging and payout of the cable assembly 100.

Still with reference to FIG. 1, the cable assembly 100 can optionally include a spacer element 128 positioned between the first bare cable 114 and the second connector 122. The spacer element 128 can function to prevent contact between the first bare cable 114 and the second connector 122, thereby substantially preventing or minimizing damage to the first bare cable 114 and/or the second connector 122. Although the spacer element 128 is shown in FIG. 1 as an independent structure, the spacer element 128 can be formed as an extension of the coupler element 126 structure. The spacer element 128 can be fabricated from, e.g., foam, STYROFOAM®, a non-conductive material, and the like.

In some embodiments, the spacer element 128 can define an I-shaped form to, e.g., ensure separation between the first bare cable 114 and the second connector 122, limit translation of the first bare cable 112 and the second connector 122, and the like. For example, the spacer element 128 can include an elongated body section 130 and end protrusions 132 on opposing ends of the elongated body section 130. The elongated body section 130 and the end protrusions 132 can be dimensioned such that when the first bare cable 114 and/or the second connector 122 are positioned adjacent to the spacer element 128, the end protrusions 132 are positioned immediately adjacent to the sides of the first bare cable 114 and/or the second connector 122 to prevent or reduce translation of the first bare cable 112 and/or the second connector 122 within the coupler element 126. In some embodiments, the distance between the end protrusions 132 on one end of the spacer element 128 can be different from the distance between the end protrusions 132 on the opposing end to accommodate the different sizes and configurations of the first bare cable 114 and the second connector 122.

FIG. 2 shows an exemplary cable assembly 200 which is substantially similar in structure and function to the cable assembly 100 of FIG. 1, except for the distinctions noted herein. Therefore, like reference numbers represent like structures. In particular, the coupler element 202, e.g., a clip coupler, a cover, one or more elongated bands, and the like, can be used to detachably secure the first bare cable 114 relative to the second connector 122 in a different orientation. For example, as shown in FIG. 2, the first cable 102 and the second cable 104 can be detachably secured relative to each other by the coupler element 202 such that the first bare cable 114 and the second connector 122 are in an adjacent, co-planar and side-by-side relation. The coupler element 202 can, for example, surround, cover and/or encase the first bare cable 114 and the second connector 122. In some embodiments, the coupler element 202 can surround, cover and/or encase portions of the first and second elongated cords 106, 116 adjacent to the first bare cable 114 and/or the second connector 122.

The adjacent, co-planar and side-by-side relation can be represented by the side of the first elongated cord 106 being positioned adjacent to the side of second connector 122. The first and second cables 102, 104 are thereby positioned such that the first and second elongated cords 106, 116 are substantially parallel relative to each other. In addition, the adjacent, co-planar and side-by-side relation can be represented by the second end 110 of the first cable 104 with the first bare cable 114 being substantially aligned with an area of engagement between the second connector 122 and the second elongated cord 116. The first cable 102 and the second cable 104 can be detached from the coupler element 202 (and from each other) by, e.g., pulling the first bare cable 114 or the second connector 122 from the coupler element 202, breaking or tearing the coupler element 202, releasing or opening the spring-loaded surfaces of the coupler element 202, and the like.

Although illustrated without a spacer element, it should be understood that a spacer element can optionally be positioned between the first bare cable 114 and the second connector 122. For example, the spacer element can define an S-shaped form to provide a separation between the first bare cable 114 and the second connector 122, while at least partially wrapping around the second end 110 of the first cable 104 and the first end 118 of the second cable 106 to limit translation of and/or prevent damage to the first bare cable 114 and the second connector 122 within the coupler element 202.

FIG. 3 shows an exemplary cable assembly 300 which is substantially similar in structure and function to the cable assemblies 100, 200 of FIGS. 1 and 2, except for the distinctions noted herein. Therefore, like reference numbers represent like structures. In particular, the coupler element 302, e.g., a clip coupler, a cover, one or more elongated bands, and the like, can be used to detachably secure the first bare cable 114 relative to the second connector 122 in a different orientation. For example, the first cable 102 and the second cable 104 can be detachably secured relative to each other by the coupler element 302 such that the first bare cable 114 and the second connector 122 are in a passing, co-planar and side-by-side relation. The coupler element 302 can, for example, surround, cover and/or encase the first bare cable 114 and the second connector 122. In some embodiments, the coupler element 302 can surround, cover and/or encase portions of the first and second elongated cords 106, 116 adjacent to the first bare cable 114 and/or the second connector 122.

The passing, co-planar and side-by-side relation can be represented by the side of the first elongated cord 106 being positioned adjacent to the side of second connector 122. The first and second cables 102, 104 are thereby positioned such that the first and second elongated cords 106, 116 are substantially parallel relative to each other. As can be seen from FIG. 3, the passing, co-planar and side-by-side relation can be further represented by the second end 110 of the first cable 102 with the first bare cable 114 passing an area of engagement between the second connector 122 and the second elongated cord 116, resulting in the first bare cable 114 being positioned adjacent to the second elongated cord 116 and the second connector 122 being positioned adjacent to the first elongated cord 106. The first cable 102 and the second cable 104 can be detached from the coupler element 302 (and from each other) by, e.g., pulling the first bare cable 114 or the second connector 122 from the coupler element 302, breaking or tearing the coupler element 302, releasing or opening the spring-loaded surfaces of the coupler element 302, and the like.

Although illustrated without a spacer element, it should be understood that a spacer element can optionally be positioned between, e.g., the first bare cable 114 and the second elongated cord 116, the second connector 122 and the first elongated cord 106, combinations thereof, and the like. For example, the spacer element can define an S-shaped form to provide a separation between the first bare cable 114, the second connector 122 and the first and second elongated cords 106, 116, while at least partially wrapping around the second end 110 of the first cable 104 and the first end 118 of the second cable 106 to limit translation of and/or prevent damage to the first bare cable 114 and the second connector 122 within the coupler element 202.

FIG. 4 shows an exemplary cable assembly 400 which is substantially similar in structure and function to the cable assemblies 100, 200, 300 of FIGS. 1-3, except for the distinctions noted herein. Therefore, like reference numbers represent like structures. In particular, the coupler element 402, e.g., a clip coupler, a cover, one or more elongated bands, a rubber band, adhesive tape, and the like, can be used to detachably secure the first bare cable 114 relative to the second connector 122 in a passing and co-planar orientation. For example, the first cable 102 and the second cable 104 can be detachably secured relative to each other by the coupler element 402 such that the first bare cable 114 and the second connector 122 are in a passing and co-planar relation.

As can be seen in FIG. 4, the passing and co-planar relation can be represented by the first bare cable 114 completely passing the second connector 122, resulting in the first bare cable 114 being positioned adjacent to the second elongated cord 116 and the second connector 122 being positioned adjacent to the first elongated cord 106. The first and second cables 102, 104 are thereby positioned such that the first and second elongated cords 106, 116 are substantially parallel relative to each other. In addition, rather than coupling the first bare cable 114 and the second connector 122, the coupler element 402 detachably couples the first and second elongated cords 106, 116. For example, the coupler element 402 can surround, cover and/or encase a portion of the first and second elongated cords 106, 116 between the first and second ends 108, 118, 110, 120, respectively. Thus, rather than surrounding, covering and/or encasing the first bare end 114 and the second connector 122, the coupler element 402 can detachably secure the first and second cables 102, 104 by the first and second elongated cords 106, 116. The first cable 102 and the second cable 104 can be detached from the coupler element 402 (and from each other) by, e.g., pulling the first bare cable 114 or the second connector 122 from the coupler element 402, breaking or tearing the coupler element 402, releasing or opening the spring-loaded surfaces of the coupler element 402, and the like.

Although illustrated without a spacer element, it should be understood that a spacer element can be positioned between, e.g., the first bare cable 114 and the second elongated cord 116, the second connector 122 and the first elongated cord 106, combinations thereof, and the like. For example, the spacer element can define an S-shaped form to provide a separation between the first bare cable 114, the second connector 122 and the first and second elongated cords 106, 116, while at least partially wrapping around the second end 110 of the first cable 104 and the first end 118 of the second cable 106 to limit translation of and/or prevent damage to the first bare cable 114 and the second connector 122 secured by the coupler element 402.

The exemplary cable assemblies discussed herein generally allow a more cost effective and efficient packaging, organization, removal and/or installation of cables. For example, the cable assemblies discussed herein provide an organized means of packaging cables for future removal and/or installation. Although only two cables 102 and 104 are illustrated in FIGS. 1-4, it should be understood that the cable assemblies may be utilized with a plurality of cable pairs and such pairs may be advantageously stacked or otherwise combined for inventory and/or shipping purposes. Thus, rather than removing each cable individually from a sealed package, the cable assemblies allow for a plurality of cables, e.g., patch cords, fiber optic cords, and the like, to be packaged together and individually removed by detaching the desired cable from the coupler element.

With reference to FIG. 5, a cutaway view of an exemplary embodiment of a system 500 of cable assembly packaging and payout, e.g., a cable assembly housing, is illustrated. It should be understood that the system 500 can be used with any of the cable assemblies (or combinations of the cable assemblies) discussed herein. The system 500 generally includes a housing 502 and an opening (not shown) for dispensing cables. For example, the opening can be located on one of the housing 502 walls and allows a user to pull cables out for use. The housing 502 can be fabricated from, e.g., plastic, metal, cardboard, or the like, and can include a base 504 and a cover 506, e.g., a lid. In some embodiments, the housing 502 can be collapsible. The base 504 can be configured and dimensioned to provide a bottom surface and side walls for surrounding the cable assemblies 508 disposed within the housing 502, while leaving a top surface open for replacement of cable assemblies 508. Rather than including a rotating core for holding a plurality of cable assemblies 508, the plurality of cable assemblies 508 can be continuously coiled within the housing 502. The plurality of cable assemblies 508 can include cables detachably secured relative to each other by any of the exemplary means discussed herein.

As illustrated in FIG. 5, continuous coiling of the plurality of cable assemblies 508 generally allows for dispensing of cables through an opening in the housing 502 from an outer coil diameter 510. For example, the cable assemblies 508 can be coiled to define inner coils of the cable assemblies 508 which define an inner coil diameter 512 and further cable assemblies 508 coiled around the inner coil diameter 512 to define outer coils of the cable assemblies 508 which define an outer coil diameter 510. Thus, the plurality of cable assemblies 508 can be coiled such that pulling on a cable protruding from the housing 502 directs the uncoiling direction of the plurality of cables from the outer coil diameter 510 to the inner coil diameter 512. For example, by pulling on a cable protruding from the housing 502, the plurality of cables can initially unwind from an outer coil layer before unwinding from the subsequent inner coil layer.

In some embodiments, the housing 502 can include a vertical rotating core 514 around which the plurality of cable assemblies 508 can be coiled. The vertical rotating core 514 can rotate as a cable is pulled from the housing 502, thereby providing a smoother extraction of cables from the housing 502. In some embodiments, the vertical rotating core 514 can be detachable from the base 504 to permit replacement of the coil of cable assemblies 508 after all cables have been used. In some embodiments, the housing 502 can include a coupler element remover which assists a user in removing the coupler element from the cables and/or removing the cables from the coupler element. In some embodiments, the housing 502 can include a handle 516, e.g., a strap, one or more side openings configured to receive a user's fingers, and the like, for lifting and transporting the system 500.

With reference to FIG. 6, a cutaway view of an alternative exemplary embodiment of a system 600 of cable assembly packaging and payout, e.g., a cable assembly housing, is illustrated. It should be understood that the system 600 can be used with any of the cable assemblies (or combinations of the cable assemblies) discussed herein. The system 600 can be substantially similar in structure to the system 500 described above, including a housing 602 defined by a base 604 and a cover 606. The system 600 includes a plurality of cable assemblies 608 continuously coiled within the housing 602 such that dispensing of cables occurs from an inner coil diameter 610 to an outer coil diameter 612. For example, the cable assemblies 608 can be coiled to define outer coils of the cable assemblies 608 which define the outer coil diameter 612 and further cable assemblies 608 can be coiled within the outer coil diameter 612 to define inner coils of the cable assemblies 608 which define the inner coil diameter 610. Thus, the plurality of cable assemblies 608 can be coiled such that pulling on a cable protruding from the housing 602 directs the uncoiling direction of the plurality of coils from an inner coil diameter 610 to an outer coil diameter 612. For example, by pulling on a cable protruding from the housing 602, the plurality of cables can initially unwind from an inner coil layer before unwinding from the subsequent surrounding outer coil layer.

In some exemplary embodiments, the housing 602 can include a vertical rotating core 614 around which the plurality of cable assemblies 608 can be coiled. The vertical rotating core 614 can rotate as a cable is pulled from the housing 602, thereby providing a smoother extraction of cables from the housing 602. In some embodiments, the vertical rotating core 614 can be detachable from the base 604 to permit replacement of the coil of cable assemblies 608 after all cables have been used. In some embodiments, the housing 602 can include a coupler element remover which assists a user in removing the coupler element from the cables and/or removing the cables from the coupler element. In some embodiments, the housing 602 can include a handle 616, e.g., a strap, one or more side openings configured to receive a user's fingers, and the like, for lifting and transporting the system 600.

With reference to FIG. 7, a cutaway view of an alternative exemplary embodiment of a system 700 of cable assembly packaging and payout, e.g., a cable assembly housing, is illustrated. The system 700 generally includes a housing 702 and at least one opening 704. The opening 704 can include outwardly directed flaps 706 hingedly joined to at least a portion of the perimeter of the opening 704. The flaps 706 can form a slot which permits the passage of cables therethrough. In addition, if a cable begins to slide back into the housing 702, the flaps 706 can prevent the cable from receding back into the housing 702 by, e.g., preventing the plugs from passing through the opening 704, creating friction against the elongated cord, and the like. For example, the flaps 706 can hingedly swing in an outward direction away from the opening 704 and away from the housing 702 to increase the size of the opening 704 and to allow extraction of a cable therefrom. Similarly, if a cable begins to slide or recede back into the housing 702, the flaps 706 can hingedly swing in the direction of the housing 702 to reduce the size of the opening 704, thereby preventing passage of the cable back into the housing 702.

Cable assemblies 708a-d can be continuously reeled within the housing 702 around a rotating core 710, e.g., a spool. Although illustrated with four cable assemblies 708a-d, it should be understood that the system 700 can be implemented with, e.g., one, two, three, four, five, six, seven, eight, and the like, cable assemblies. Thus, one housing 702 can include a plurality of cables varying by, e.g., plug type, length, color, and the like. The rotating core 710 can include at least one partition 712 positioned coaxially around the rotating core 710, thereby separating the plurality of cable assemblies 708a-d. The rotating core 710 can include, e.g., thrust washers, and the like, to ensure that each cable assembly 708a-d can be dispensed independently of the other cable assemblies 708a-d.

For example, the first cable assembly 708a can be dispensed from the housing 702, while the second, third and fourth cable assemblies 708b-d remain substantially static around the rotating core 710. Each cable assembly 708a-d can therefore rotate independently of the other cable assemblies 708a-d on the rotating core 710. A user can thereby select and dispense a cable of interest without dispensing the other cables located in the exemplary housing 702. In some embodiments, the housing 702 can include a selection element (not shown) which permits a user to select whether the cable assemblies 708a-d rotate independently of each other or rotate simultaneously. In some embodiments, the housing 702 can include a coupler element remover which assists a user in removing the coupler element from the cables and/or removing the cables from the coupler element. In some embodiments, the housing 702 can include a handle 714, e.g., a strap, one or more side openings configured to receive a user's fingers, and the like, for lifting and transporting the system 700.

Although discussed herein as, e.g., a clip coupler, a cover, one or more elongated bands, a rubber band, adhesive tape, and the like, it should be understood that a variety of coupler elements can be used. In addition, although cable assembly housing systems are discussed herein, it should be understood that a variety of systems can be used. U.S. patent application entitled “Patch Cord Assemblies, Methods and Systems,” which published as U.S. Patent Publication No. 2013/0115808, U.S. patent application entitled “Patch Cord Assemblies, Methods and Systems,” which published as U.S. Patent Publication No. 2013/0115806, and U.S. patent application entitled “Patch Cord Assemblies, Methods and Systems,” which published as U.S. Patent Publication No. 2013/0210264, disclose a variety of coupler element and cable assembly housing configurations. It should be understood that the exemplary cable assemblies and cable assembly housings discussed herein can be utilized in conjunction with and/or replaced with the coupler elements and/or cable assembly housings as taught by the foregoing applications, the contents of which are incorporated herein by reference.

While exemplary embodiments have been described herein, it is expressly noted that these embodiments should not be construed as limiting, but rather that additions and modifications to what is expressly described herein also are included within the scope of the invention. Moreover, it is to be understood that the features of the various embodiments described herein are not mutually exclusive and can exist in various combinations and permutations, even if such combinations or permutations are not made express herein, without departing from the spirit and scope of the invention.

1. A cable assembly, comprising:
a first cable that includes a first elongated cord defining two ends, a first connector mounted with respect to one end of the first elongated cord, and a first bare cable defining an opposing end of the first elongated cord,
a second cable that includes a second elongated cord defining two ends, a second connector mounted with respect to one end of the second elongated cord, and a second bare cable defining an opposing end of the second elongated cord, and
a coupler element for detachably securing the first cable relative to the second cable with the first bare cable and the second connector in a juxtaposed relation.

2. The cable assembly of claim 1, wherein the first connector is at least one of a plug or a jack.

3. The cable assembly of claim 1, wherein the second connector is at least one of a plug or a jack.

4. The cable assembly of claim 1, wherein the coupler element is at least one of a clip, a cover, an elongated band, a rubber band, and adhesive tape.

5. The cable assembly of claim 1, wherein the juxtaposed relation is at least one of an adjoining relation, an opposed relation, a side-by-side relation, a co-planar relation, a spaced relation, and a passing relation.

6. The cable assembly of claim 1, comprising at least one spacer element removably positioned between the first bare cable and the second connector.

7. The cable assembly of claim 6, wherein the at least one spacer element at least one of prevents damage to the first bare cable and the second connector, and limits movement of the first bare cable and the second connector relative to each other.

8. The cable assembly of claim 1, wherein the coupler element completely surrounds, covers or encases the first bare end and the second connector.

9. A method of detachably associating a first cable with a second cable to define a cable assembly, comprising:
detachably securing a first cable relative to a second cable using a coupler element,
wherein the first cable includes a first elongated cord defining two ends, a first connector mounted with respect to one end of the first elongated cord, and a first bare cable defining an opposing end of the first elongated cord,
wherein the second cable includes a second elongated cord defining two ends, a second connector mounted with respect to one end of the second elongated cord, and a second bare cable defining an opposing end of the second elongated cord,
wherein the first bare cable and the second connector are detachably secured in a juxtaposed relation.

10. The method of claim 9, comprising removably positioning at least one spacer element between the first bare cable and the second connector.

11. A system of cable assembly packaging and payout, comprising:
a housing for packaging and payout of at least one cable assembly,
wherein the at least one cable assembly comprises (i) at least a first cable that includes a first elongated cord defining two ends, a first connector mounted with respect to one end of the first elongated cord, and a first bare cable defining an opposing end of the first elongated cord, (ii) at least a second cable that includes a second elongated cord defining two ends, a second connector mounted with respect to one end of the second elongated cord, and a second bare cable defining an opposing end of the second elongated cord, and (iii) a coupler element for detachably securing the at least first cable relative to the at least second cable with the first bare cable and the second connector in a juxtaposed relation, and at least one housing opening for paying out the at least first cable.

12. The system of claim 11, comprising a coupler element remover, the coupler element remover being configured and dimensioned to separate the at least first cable and the at least second cable from the coupler element.

13. The system of claim 11, wherein the at least first and second cables are continuously reeled within the housing around a rotating core.

14. The system of claim 13, wherein the rotating core includes at least one partition.

15. The system of claim 14, wherein the at least one partition separates and permits independent rotation of at least a first cable assembly relative to a second cable assembly.

16. The system of claim 11, wherein the at least one housing opening is configured and dimensioned to prevent the at least first cable from receding back into the housing.

17. The system of claim 11, wherein the housing comprises a handle configured and dimensioned to permit lifting of the housing.

18. The system of claim 11, wherein the at least first and second cables are continuously coiled within the housing.

19. The system of claim 18, wherein the at least first and second cables are continuously coiled within the housing for dispensing from an outer coil diameter to an inner coil diameter.

20. The system of claim 18, wherein the at least first and second cables are continuously coiled within the housing for dispensing from an inner coil diameter to an outer coil diameter.
